(19) United States
(12) Patent Application Publication
(10) Pub. No.: US 2019/0191712 A1
(43) Pub. Date: Jun. 27, 2019

(54) Method for Control of Insect on Poultry

(71) Applicant: Novozymes A/S, Bagsvaerd (DK)

(72) Inventor: Seth D'Imperio, Bozeman, MT (US)

(73) Assignee: Novozymes A/S, Bagsvaerd (DK)

(21) Appl. No.: 16/307,651

(22) PCT Filed: Jul. 13, 2017
(86) PCT No.: PCT/US2017/041908

§ 371 Date: Dec. 6, 2018

Related U.S. Application Data
(60) Provisional application No. 62/361,677, filed on Jul. 13, 2016.

(51) Int. Cl. A01N 63/04; C12R 1/645

(52) U.S. Cl. CPC A01N 63/04; A01M 1/2022; A01M 2200/01; C12R 1/645

(57) ABSTRACT

The invention relates to a method for reducing or eliminating insect pests on poultry comprising: i) preparing a biopesticide composition having an effective amount of one or more entomopathogenic fungi; and ii) administering said biopesticide composition to the poultry by spraying.

### REFERENCE TO A DEPOSIT OF BIOLOGICAL MATERIAL

This application contains a reference to a deposit of biological material, which deposit is incorporated herein by reference. For complete information see the detailed description of the invention.

### FIELD OF THE INVENTION

The present invention relates to insect pest controlling compositions comprising entomopathogenic fungi and use of such compositions for controlling insect pests such as mites on poultry.

### BACKGROUND OF THE INVENTION

Lice and mites are common poultry pests. They feed on the blood, feathers, skin or scales of the poultry. Heavy infestation can result in poor poultry health, reduced growth and egg production, and even the death of the poultry.

Current solutions to the issues of insect pests in, e.g., poultry facilities include the use of several chemical insecticides including organophosphates, neonicotinamides, and pyrethroids. Due to continued use of these insecticides, many insect pests have developed resistance to their efficacy.

Biopesticides have been developed for use as an alternative, or in some cases as a supplement, to chemical pesticides, e.g., for agriculture. Biopesticides are living organisms (e.g., fungi and bacteria) that intervene in the life cycle of pests (by killing or disabling the pest). Examples of biopesticides include the entomopathogenic fungus Metarhizium anisopliae, which has been registered as a bio-insecticide for the control of insect pests on plants in the United States and many other countries. Metarhizium anisopliae has been reported to infect many insect types including subterranean termites (Reticulitermes and Coptotermes spp.), corn rootworms (Diabrotica spp), black vine weevils (Otiorhynchus sulcatus), citrus root weevils (Diaprepes abbreviatus), Japanese beetles (Popillia japonica), and European chafers (Rhizotrogus majalis).

U.S. Pat. No. 5,189,831 discloses a method for control and extermination of flying insects, especially the housefly, by infection of the insects with an entomopathogenic fungus, preferably, soil-dwelling fungi, by means of an infection chamber.

Brooks et al. (Brooks et al., 2001, Infection of Psoroptes mites with the fungus Metarhizium anisopliae. Exp. Appl. Acarol. 25: 869-880) discloses infection of Psoroptes mites with Metarhizium anisopliae.

Pourseyed et al. (Pourseyed et al., 2010, Metarhizium anisopliae (Ascomycota: Hypocreales): An effective alternative to chemical acaricides against different developmental stages of fowl tick Argas persicus (Acari: Argasidae). Vet. Parasitol. 172: 305-310) discloses that three strains termed V245, 685 and 715C of entomopathogenic fungus Metarhizium anisopliae are effective against different life stages of A. persicus including eggs, larvae, unfed and engorged adult females under laboratory conditions.

Tavassoli et al. (Tavassoli et al., 2011, Field bioassay of Metarhizium anisopliae strains to control the poultry red mite Dermanyssus gallinae, Vet. Parasitol. 178(3-4): 374-378) discloses that three strains termed V245, 3247 and 715C of entomopathogenic fungus Metarhizium anisopliae are effective against poultry red mite Dermanyssus gallinae.

### SUMMARY OF THE INVENTION

It has been demonstrated that an effective way of controlling insect pests on poultry comprises spraying of the poultry with a biopesticide composition having an effective amount of one or more entomopathogenic fungi such as one or more Metarhizium spp., e.g., Metarhizium anisoplia.

Accordingly, the invention relates to a method for controlling insect pests on poultry comprising:

(a) preparing a biopesticide composition having an effective amount of one or more entomopathogenic fungi such as, e.g., Metarhizium spp.; and

(b) spraying said biopesticide composition onto the poultry.

The invention further relates to biopesticide compositions for use in controlling insect pests on poultry, where the biopesticide compositions comprise one or more entomopathogenic fungi such as, e.g., Metarhizium spp., at least one surfactant and/or at least one carrier.

### Definitions

In general, the terms and phrases used herein have their art-recognized meaning, which can be found by reference to standard texts, journal references, and context known to those skilled in the art. The following definitions are provided to clarify their specific use in context of the disclosure.

As used herein, the singular forms “a”, “an” and “the” are intended to include the plural forms as well, unless the context clearly indicates otherwise.

It is to be understood that the fungal strain used in accordance with the methods of the invention may be Metarhizium anisopliae strain F52 (also known as Metarhizium anisopliae strain 52, Metarhizium anisopliae strain 7, Metarhizium anisopliae strain 43, Metarhizium anisopliae BIO-1020, TAE-001 and previously deposited as DSM 3884, DSM 3885, ATCC 90448, SD 170, and ARSEF 7711) (available from Novozymes Biologicals, Inc., USA); however, the fungal strain may also be a culture of strain having properties substantially similar to the above mentioned isolated and deposited strains. Preferred properties include those properties of controlling insect pests on poultry.

As used herein, the term “control” or “controlling” as in, e.g., the phrase: the “control” of insect pests, refers to preventing, reducing, killing, inhibiting the growth of, or elimination of an insect or insect population as defined herein. Indeed, “control” or “controlling” as used herein refers to any indicia of success in prevention, killing, inhibition, elimination, reduction or amelioration of an insect or insect population.

As used herein the term “vent” is the common outside opening of the cloaca in poultry through which the digestive, excretory and reproductive tracts empty. The “vent area” is defined as the vent including the area surrounding the vent such as, e.g., a circular area centered around the vent, wherein the circular area has a diameter of, e.g., 1 cm to 2 cm, 2 cm to 3 cm, 3 cm to 4 cm, 4 cm to 5 cm, 5 cm to 6 cm, 6 cm to 7 cm, 7 cm to 8 cm, 8 cm to 9 cm, 9 cm to 10 cm, or any combination of these intervals.

As used herein the term “Insect pests” is defined as any insect that infests poultry. These include a variety of insects such as mites, fleas, flies, louse, ticks and bugs that live on the skin and feed on skin debris, fur, feathers and/or blood.

As used herein, the terms “effective amount”, “effective concentration”, or “effective dosage” are defined as the amount, concentration, or dosage of entomopathogenic fungi sufficient to cause infection in the insect which will then lead to the reduction or elimination the insect. The actual effective dosage in absolute value depends on factors including, but not limited to, the mortality rate of the target insects relative to the rate at which Metarhizium spp., such as, e.g., Metarhizium brunneum or Metarhizium anisopliae, is able to infect the insect and propagate within the cadaver while excluding other microorganisms, synergistic or antagonistic interactions between the other active or inert ingredients which may increase or reduce the activity of Metarhizium spp., e.g., Metarhizium brunneum or Metarhizium anisopliae, the inherent susceptibility of the life stage and species of insect, and the stability of the Metarhizium spp., e.g., Metarhizium brunneum or Metarhizium anisopliae, in formulations.

The term “poultry” means domesticated birds kept by humans for the eggs they produce and/or their meat and/or their feathers. Poultry includes broilers and layers. Poultry include members of the superorder Galloanserae (fowl), especially the order Galliformes (which includes chickens, Guineafowls, quails and turkeys) and the family Anatidae, in order Anseriformes, commonly known as “waterfowl” and including domestic ducks and domestic geese. Poultry also includes other birds that are killed for their meat, such as the young of pigeons. Examples of poultry include chickens (including layers, broilers, breeders, and chicks), ducks, geese, pigeons, turkeys and quail.

As used herein, the term “spore” has its normal meaning which is well known and understood by those of skill in the art. As used herein, the term “spore” refers to a microorganism in its dormant, protected state.

As used herein, the term “carrier” is intended to refer to a biologically acceptable carrier.” A “biologically acceptable carrier” is intended to refer to any material which can be used to deliver the actives (e.g., microorganisms described herein, agriculturally beneficial ingredient(s), biologically active ingredient(s), etc.) to an animal, and, preferably, which carrier can be applied to the animal without having an adverse effect on animal growth, health or the like.

As used herein, the term “insecticide(s)” is intended to refer to any agent or combination of agents capable of killing one or more insects and/or inhibiting the growth of one or more insects.

As used throughout this specification, the terms “parts by weight” or “percentage weight” are used interchangeably in the specification wherein the weight percentages of each of the individual constituents are indicated in weight percent based on the total weight of the particular composition of which it forms a part.

As used herein the terms “spray” and “spraying” are to be understood broadly meaning administration of a liquid, semi-solid or solid formulation (such as a powder formulation) comprising the biopesticide composition of the invention onto the outer surface of the poultry (e.g., onto the feathers and/or the skin). An example of the meaning of the term “spray” is to disperse a liquid or semi-liquid formulation comprising the biopesticide composition of the invention in a jet of droplets, particles, or small pieces onto the outer surface of the poultry.

### DETAILED DESCRIPTION OF THE INVENTION

The present invention relates in a first aspect to a method for controlling insect pests on poultry comprising:

(a) preparing a biopesticide composition having an effective amount of one or more entomopathogenic fungi, such as, e.g., Metarhizium spp.; and

(b) spraying said biopesticide composition onto the poultry.

In one aspect, the method for controlling insect pests on an animal comprises spraying said biopesticide composition onto the animal.

According to an embodiment, the biopesticide composition comprises one or more entomopathogenic fungi such as, e.g., Metarhizium spp., at least one surfactant and/or at least one carrier.

Specific embodiments of the method according to the first aspect are described herein below.

Entomopathogenic fungi include Metarhizium spp., Beauveria spp., Paecilomyces spp, Lecanicillium spp., and Hirsutella spp. In a preferred embodiment, the entomopathogenic fungi is Metarhizium spp. The biopesticide composition can also be a combination of entomopathogenic fungi comprising 2, 3, 4, 5, 6, 7, 8, 9 10 or more than 10 different entomopathogenic fungi, such as e.g. 1, 2, 3, 4, 5, 6, 7, 8, 9 or more than 9 different entomopathogenic fungi together with Metarhizium spp. In another embodiment, the biopesticide composition comprises an entomopathogenic fungi, such as, e.g., Metarhizium spp., and a further fungi capable of controlling insect pests on poultry. In a specific embodiment, the biopesticide composition comprises at least two entomopathogenic fungi wherein one entomopathogenic fungi is a Metarhizium spp. and one or more further entomopathogenic fungi is selected from the group consisting of Beauveria spp., Paecilomyces spp, Lecanicillium spp., and Hirsutella spp. In a preferred embodiment, the biopesticide composition comprises a Metarhizium anisopliae or a Metarhizium brunneum. In another preferred embodiment, the biopesticide composition comprises a Metarhizium anisopliae. In another preferred embodiment, the biopesticide composition comprises a Metarhizium brunneum. In an even more preferred embodiment, the entomopathogenic fungus is Metarhizium anisopliae strain F52 (also known as Metarhizium anisopliae strain 52, Metarhizium anisopliae strain 7, Metarhizium anisopliae strain 43, Metarhizium anisopliae BIO-1020, TAE-001, MET52® and previously deposited as DSM 3884, DSM 3885, ATCC 90448, SD 170, and ARSEF 7711; available from Novozymes Biologicals, Inc., USA). In relation to the present invention the Metarhizium anisopliae strain F52 has been deposited as NRRL 67280. In still another particular embodiment, the biopesticide composition comprises at least one fungal pesticide comprising spores of the Metarhizium anisopliae strain F52.

The biopesticide composition of step (b) is in one preferred embodiment in a liquid form. Alternatively, the biopesticide composition can be in a semi-solid form or a solid form such as in a powder form.

In another embodiment, the biopesticide composition having an effective amount of one or more entomopathogenic fungi, such as e.g. Metarhizium spp., further comprises a chemical pesticide. In yet another embodiment, the method of the invention further comprises administration of a chemical pesticide to the poultry. The administration of a chemical pesticide to the poultry can be performed either before, after or simultaneously with step (b) of the method according to the first aspect. The chemical pesticide can be a bait formulation, a sprayable formulation, and/or a dustable formulation. In one embodiment, the chemical pesticide includes an active ingredient selected from the group consisting of boric acid, abamectin, fipronil, hydramethylnon, indoxacarb, and imidacloprid.

In one embodiment, the spraying in step (b) is only performed once. In another embodiment, spraying is performed more than once such as 2, 3, 4, 5, 6, 7, 8, 9, 10 or more than 10 times. The time interval between the sprayings can be, e.g., 2 to 4 hours, 4 to 6 hours, 6 to 8 hours, 8 to 10 hours, 10 to 12 hours, 12 to 14 hours, 14 to 16 hours, 16 to 18 hours, 18 to 20 hours, 20 to 22 hours or 22 to 24 hours, or any combination of these intervals. The time interval between the sprayings can be, e.g., 1 to 2 days, 2 to 3 days, 3 to 4 days, 4 to 5 days, 5 to 6 days, 6 to 7 days, 7 to 8 days, 8 to 9 days, 9 to 10 days, 10 to 11 days, 11 to 12 days, 12 to 13 days, 13 to 14 days, 14 to 15 days, 15 to 16 days, 16 to 17 days, 17 to 18 days, 18 to 19 days, 19 to 20 days, 20 to 21 days, 21 to 22 days, 22 to 23 days, 23 to 24 days, or any combination of these intervals. In another embodiment, the time interval between the sprayings can be, e.g., 1 week, 2 weeks, 3 weeks, 4 weeks etc.

The administration of the biopesticide composition having an effective amount of one or more entomopathogenic fungi, such as, e.g., Metarhizium spp., can be applied to the poultry by spaying followed by administration by one or more other means such as submerging the poultry in a solution comprising the one or more entomopathogenic fungi or by oral administration of the one or more entomopathogenic fungi.

The method according to the invention comprises spraying of one or more entomopathogenic fungi, such as e.g. Metarhizium spp., preferably, at a dosage from 1×10⁴ to 1×10⁷ conidia per square cm poultry surface such as skin, feathers, or hair. In a specific embodiment, the method according to the invention comprises spraying of one or more entomopathogenic fungi at a dosage selected from the group consisting of from 1×10⁴ to 1×10⁵ conidia per square cm poultry surface, from 1×10⁵ to 1×10⁶ conidia per square cm poultry surface, and from 1×10⁶ to 1×10⁷ conidia per square cm poultry surface or any combination of these intervals.

In a preferred embodiment, the method of the invention results in controlling of insect pests by reducing the number of the one or more types of insects on the poultry (compared to untreated poultry). In a specific embodiment, the method of the invention results in that the number of the one or more types of insects on the poultry is reduced by at least 5%, such as at least 10%, for example by at least 15%, such as by at least 20%, for example by at least 25%, such as by at least 30%, for example by at least 35%, such as by at least 40%, for example by at least 45%, such as by at least 50%, for example by at least 55%, such as by at least 60%, for example by at least 65%, such as by at least 70%, for example by at least 75%, such as by at least 80%, for example by at least 85%, such as by at least 90%, for example by at least 95%, such as by at least 99%, or for example by 100% (compared to untreated poultry).

In a specific embodiment, the method of the invention results in that the number of the one or more types of insects on the poultry is reduced by at least 5%, such as at least 10%, for example by at least 15%, such as by at least 20%, for example by at least 25%, such as by at least 30%, for example by at least 35%, such as by at least 40%, for example by at least 45%, such as by at least 50%, for example by at least 55%, such as by at least 60%, for example by at least 65%, such as by at least 70%, for example by at least 75%, such as by at least 80%, for example by at least 85%, such as by at least 90%, for example by at least 95%, such as by at least 99%, or for example by 100% (compared to untreated poultry) determined 24 hours, 48 hours, 72 hours or 96 hours after the administration.

In a specific embodiment, the method of the invention results in that the number of the one or more types of insects on the poultry is reduced by at least 5%, such as at least 10%, for example by at least 15%, such as by at least 20%, for example by at least 25%, such as by at least 30%, for example by at least 35%, such as by at least 40%, for example by at least 45%, such as by at least 50%, for example by at least 55%, such as by at least 60%, for example by at least 65%, such as by at least 70%, for example by at least 75%, such as by at least 80%, for example by at least 85%, such as by at least 90%, for example by at least 95%, such as by at least 99%, or for example by 100% (compared to untreated poultry) determined 1 day, 2 days, 3 days, 4 days, 5 days, 6 days or 7 days after the administration.

In an embodiment, the method of the invention results in controlling of insect pests by partly or completely extermination of the insects of one or more types on the poultry (compared to untreated poultry).

In an embodiment, the method of the invention results in controlling of insect pests by partly or completely extermination of the insects of one or more types on the poultry (compared to untreated poultry) determined 24 hours, 48 hours, 72 hours or 96 hours after the administration.

In an embodiment, the method of the invention results in controlling of insect pests by partly or completely extermination of the insects of one or more types on the poultry (compared to untreated poultry) determined 1 day, 2 days, 3 days, 4 days, 5 days, 6 days or 7 days after the administration.

The method according to the invention relates in one embodiment to controlling of insect pests on poultry selected from the group consisting of Galloanserae, Anatidae, Galliformes, Anseriformes chickens, guineafowls, quails, turkeys, ducks and geese. In a preferred embodiment, the poultry is selected from broilers and layers.

The method according to the invention relates in one embodiment to control of insect pest, wherein the insect to be controlled is selected from the group consisting of mites, fleas, flies, louse, ticks and bugs.

In a specific embodiment, the invention relates to controlling of an insect selected from the group consisting of Northern Fowl Mite (Ornithonyssus sylviarum), Red Mite (Dermanyssus gallinae), Chicken Flea (Ceratophyllus Gallinae), Scaly-leg Mite (Knemidokoptes mutans), Sticktight Fleas (Echidnophaga gallinacea), Chicken Body Louse (Menacanthus stramineus), Shaft Louse (Menopon gallinae), Fowl Ticks (Argas persicus), and Bedbugs (Cimex lectularius).

In one embodiment, the invention comprises spraying of the biopesticide composition onto the skin of the poultry and/or feathers of the poultry. The spraying can be a localised application—i.e., applied onto part of the outer surface of the poultry. Alternatively, the spraying can be directed to the majority or all of the outer surface of the poultry. Preferably, the spraying is done directly on the poultry using either a device targeting a single poultry at a time or a device targeting multiple poultry simultaneously. The spraying can be performed in a manual manner or in an automated or semi-automated manner.

In one embodiment, the fungal product of the invention is sprayed directly onto the vent area of poultry such as chickens in production houses for the treatment of insect pests. In another embodiment, the fungal product of the invention is sprayed over most of the body of the poultry such as all of the body or all of the body readily accessible.

### Fungal Biopesticide Composition

Different embodiments of the fungal biopesticide composition to be used in step (b) in the method according to the invention are described herein below. In addition, suitable formulations of the fungal biopesticide composition are disclosed in U.S. Ser. No. 15/034,642 and WO 2015/069708 both of which hereby are incorporated into this patent application in their entirety.

In addition to the one or more entomopathogenic fungi, such as, e.g., entomopathogenic fungi, the biopesticide composition can further comprise at least one surfactant. The at least one surfactant can in one embodiment be selected from sorbitan fatty esters, sorbitol ethoxylates esters, alcohol ethoxylates, and combinations thereof. In an even more particular embodiment, the at least one surfactant comprises a mixture of a sorbitan monostearate and a polyoxyethylene sorbitol hexaoleate. In another particular embodiment, the at least one surfactant may comprise a mixture of a sorbitan monooleate and a polyoxyethylene sorbitol hexaoleate. In another particular embodiment, the at least one surfactant may comprise a mixture of a sorbitan monostearate, a sorbitan monooleate and a polyoxyethylene sorbitol hexaoleate. In another particular embodiment, the at least one surfactant may comprise a mixture of a sorbitan monostearate and a sorbitan monooleate. In a particular embodiment, the at least one surfactant is selected from sorbitan fatty esters, sorbitol ethoxylates esters, alcohol ethoxylates and combinations thereof.

The biopesticide composition may further comprise an anti-settling agent. In a particular embodiment, the anti-settling agent comprises a fumed silica.

In still another embodiment, the biopesticide composition described herein comprises an agriculturally suitable carrier, wherein the carrier comprises a paraffinic oil, at least one fungal pesticide, wherein the at least one fungal pesticide comprises Metarhizium anisopliae or Metarhizium brunneum, at least one surfactant wherein the at least one surfactant comprises a mixture of a sorbitan monostearate and a polyoxyethylene sorbitol hexaoleate, and an anti-settling agent, wherein the anti-settling agent comprises a fumed silica. The sorbitan monostearate may be substituted with a sorbitan monooleate.

The carrier may be used to provide an environment to support the viability of the at least one fungus, including by providing the proper environmental conditions and protecting the fungal pesticide from harmful environmental conditions (e.g., excess oxygen, moisture and/or ultraviolet radiation, etc.). Unless the compositions are generated immediately prior to use, the carrier may be used to maintain the activity of the fungal pesticide during storage (e.g., in a container for the entire shelf-life of the formulated product). The carrier may also be used to maintain the activity of the fungal pesticide after the fungal pesticide compositions described throughout have been applied to the application surface. In particular embodiments, the carrier provides an environment such that the fungal pesticide will not have more than a 1-log loss of the original viable content (prior to including in a carrier) over at least a one year period. Further still, the fungal pesticides described herein are transferable from the carrier to the body of the target pest (e.g., white flies, thrips, mites, weevils, ticks, chinch bugs, etc.).

In certain embodiments, the biopesticide composition may be in the form of a gel, a foam, a solid (such as a powder, granule, particle, etc.), or a liquid. In a particular embodiment, the biopesticide composition is in the form of a liquid. In a more particular embodiment, the biopesticide composition is in the form of a liquid suspension. In an even more particular embodiment, the biopesticide composition is in the form of a liquid non-aqueous suspension.

In an embodiment, additional agriculturally beneficial ingredients (e.g., beneficial microbes, signal molecules, insecticides, fungicides, nematicides, and combinations thereof) may also be used in combination with the biopesticides described herein, including as part of the same biopesticide composition or applied as a separate treatment.

In another embodiment, the biopesticide composition further includes an insect attractant. Such attractants may include, but are not limited to, food, food aromas, and pheromones.

In another embodiment, the biopesticide composition may be added to one or more commercial products capable of killing insects. Examples of such commercial products may include, but are not limited to: Roach Prufe®; Hot Shot Max Attrax®; Roach Powder Avert®; Niban®; Stapleton's Magnetic Roach Food®; Maxforce®; Combat®; Maxforce Siege®; Hot Shot Maxattrax®; Ultra Brand Nest Destroyer Roach Bait®; and Pre-Empt Professional Cockroach Gel Bait®.

### Carrier(s):

Examples of specific carriers to be included in the biopesticide composition to be used in step (b) of the method according to the first aspect of this invention are given herein below.

The carrier preferably will have the required values (and range of values) from rheological measurements (e.g., viscosity, yield value, storage modulus, and loss modulus) to allow the fungal pesticide to remain efficacious (e.g., able to be transferred to the body of the pest with a degree of lethality, prevent settling of the fungal pesticide, allow the biopesticide to be easily redispursed and dispensed into a tank, such as a water tank, etc.) and viable once formulated.

In an embodiment, the biopesticide (i.e., the composition), may be formed of 0.01 wt. % to 99.99 wt. % of carrier. There may be minor variances when measuring the weight percentage of the carrier and the biopesticide may be formed of about 0.01 wt. % to about 99.99 wt. % of carrier. In still another embodiment, the biopesticide may be formed of 50.00 wt. % to 99.99 wt. % of carrier. Again, there may be minor variances when measuring the weight percentage of the carrier and the biopesticide may be formed of about 50.00 wt. % to about 99.99 wt. % of carrier. In still yet another embodiment, the biopesticide is formed of 50.00 wt. % to 80.00 wt. % of carrier. Yet again, there may be minor variances when measuring the weight percentage of the carrier and the biopesticide may be formed of about 50.00 wt. % to about 80.00 wt. % of carrier. Therefore, in embodiments of the biopesticides disclosed herein, the total amount of carrier may be as low as 0.01 wt. % and as high as 99.99 wt. % (e.g., between 0.01 and 99.99 wt. %). In other embodiments the total amount of the agriculturally suitable/acceptable carrier may be between about 55-57 wt. %, 54-58 wt. %, 53-59 wt. %, 52-60 wt. %, 50-62 wt. %, 48-64 wt. %, 46-66 wt. %, 44-68 wt. %, 42-70 wt. %, 40-72 wt. %, and the like.

In a particular embodiment, the carrier is a non-aqueous liquid (e.g., an oil, etc.). The non-aqueous liquid may be a biodegradable non-aqueous liquid. The non-aqueous liquid may be a “Low Vapor Pressure Volatile Organic Compounds (LVP-VOC),” which is a chemical “compound” or “mixture of compounds” containing (1) a vapor pressure less than 0.1 mm Hg at 20° C., (2) composed of chemical compounds with more than 12 carbon atoms and/or (3) a boiling point greater than 216° C. See the definition of LVP-VOC provided by the California Air Resources Board (CARB). The non-aqueous liquid may be a biodegradable LVP-VOC non-aqueous liquid.

Non-limiting examples of non-aqueous liquids suitable as a carrier for the compositions described herein include silicone oils, paraffinic/parrafin oils, mineral oils, vegetable oils, hexylene glycol, glycerol, linoleic acid, oleic acid, and any combination thereof. Non-limiting examples of a commercial mineral/paraffinic oils include BRITOL 50 (available from Sonneborn, Inc., Mahwah, N.J.), Ultra-Fine Spray oil (available from Sunoco, Petronas Lubricants, Belgium Nev.), SunSpray 6N oil (available from Sunoco, Petronas Lubricants, Belgium Nev.), SunSpray 7E Range oil (available from Sunoco, Petronas Lubricants, Belgium Nev.), SunSpray 7N oil, (available from Sunoco, Petronas Lubricants, Belgium Nev.), SunSpray 11E Range oil (available from Sunoco, Petronas Lubricants, Belgium Nev.), SunSpray 11N oil (available from Sunoco, Petronas Lubricants, Belgium Nev.), Banana Spray oil (available from Sunoco, Petronas Lubricants, Belgium Nev.), and BioSpray oil (available from Sunoco, Petronas Lubricants, Belgium Nev.). An example of silicone oil is DM Fluid 100 CS (available from Shin-Etsu Chemical Co., LtD., Tokyo, Japan).

In a particular embodiment, the carrier comprises one or more paraffinic oils. In a more particular embodiment, the carrier comprises SunSpray 6N oil (available from Sunoco, Petronas Lubricants, Belgium Nev.).

### Fungal Pesticide(s):

Examples of specific entomopathogenic fungi to be included in the biopesticide composition to be used in step (b) of the method according to the first aspect of this invention are given herein below and include Metarhizium spp.

Any suitable entomopathogenic fungi pesticide may be used, based on the targeted pest. Fungal pesticides are well known in the art. In one embodiment, the fungal pesticide may be one or more entomopathogenic fungi, such as, e.g., Metarhizium spp., one or more acaripathogenic fungi, or a combination thereof.

In an embodiment, the biopesticide (i.e., the composition), may be formed of 0.01 wt. % to 30.00 wt. % of fungal pesticide. There may be minor variances when measuring the weight percentage of the fungal pesticide and the biopesticide may be formed of about 0.01 wt. % to about 30.00 wt. % of fungal pesticide. In still another embodiment, the biopesticide may be formed of 1.00 wt. % to 15.00 wt. % of fungal pesticide. Again, there may be minor variances when measuring the weight percentage of the fungal pesticide and the biopesticide may be formed of about 1.00 wt. % to about 15.00 wt. % of fungal pesticide. In still yet another embodiment, the biopesticide is formed of 5.00 wt. % to 11.00 wt. % of fungal pesticide. Yet again, there may be minor variances when measuring the weight percentage of the fungal pesticide and the biopesticide may be formed of about 5.00 wt. % to about 11.00 wt. % of fungal pesticide. Therefore, in embodiments of the biopesticides disclosed herein, the total amount of fungal pesticide may be as low as 0.01 wt. % and as high as 30.00 wt. % (e.g., between 0.01 and 30.00 wt. %). In other embodiments, the wt. % of the fungal pesticide may be between about 10-12, 8-14, 6-16, 4-18, or the like.

In a particular embodiment, the biopesticide (i.e., the composition) is formed of 11.00 wt. % of fungal pesticide. There may be minor variances when measuring the weight percentage of the fungal pesticide and the biopesticide may be formed of about 11.00 wt. % fungal pesticide. In other embodiments, the wt. % of the fungal pesticide may be about 4, 5, 6, 7, 8, 9, 10, 12, 13, 14, 15, 16, 17 or 18.

The fungal pesticide may be produced in a liquid culture media or a solid culture media fermentation process. The media may have high carbon and nitrogen concentrations to facilitate higher yields. Not-limiting examples of suitable nitrogen sources include hydrolyzed casein, yeast extract, hydrolyzed soy protein, hydrolyzed cottonseed protein, and hydrolyzed corn gluten protein. Not-limiting examples of suitable carbon sources include carbohydrates, including glucose, fructose, and sucrose, and glycerol and/or grains such as rice or barley.

Fermentation processes may be conducted using conventional fermentation processes, such as, aerobic liquid-culture techniques, shake flask cultivation, and small-scale or large-scale fermentation (e.g., continuous, batch, fed-batch, solid state fermentation, etc.) in laboratory or industrial fermentors, and such processes are well known in the art.

Notwithstanding the production process used to produce the fungal organism, it is envisioned that the fungal pesticide may be used as a pesticide directly from the culture medium (e.g., rice) or subject to purification and/or further processing steps (e.g., a drying process). In one embodiment, following fermentation, the fungal organism may be recovered using conventional techniques (e.g., by filtration, centrifugation, mechanical recovery (e.g., shaking the fungal organism from the culture medium), etc.). The fungal organism may alternatively be dried (e.g., air-drying, freeze drying, or spray drying to a low moisture level, and storing at a suitable temperature, e.g., room temperature).

### Surfactant(s):

Examples of specific surfactants to be included in the biopesticide composition to be used in step (b) of the method according to the first aspect of this invention are given herein below.

Surfactants are well known in the art and any combination of suitable surfactants or surfactant systems may be used for the biopesticide compositions described herein. Without being bound by theory, it is believed that the surfactants suitable for the biopesticides (i.e., compositions) described herein will modify the properties of the carrier to increase the dispersion and/or suspension of the biopesticide in aqueous solutions (i.e., stabilize oil-in-water emulsions when the biopesticide is diluted with water). It is further believed that by modifying the carrier to increase the dispersion and/or suspension of the biopesticide in an aqueous solution, that the biopesticide will be able to be delivered efficiently (e.g., through a sprayer) without actives adhering/sticking to the inner walls of the delivery device or clogging the delivery components (e.g., sprayer nozzles, sprayer tubing, etc.).

Suitable surfactants for the biopesticide compositions disclosed herein will have minimal, if any negative effects, on the viability of the fungal pesticides.

In an embodiment, the biopesticide (i.e., the composition), may be formed of 1.00 wt. % to 50.00 wt. % of total surfactant. There may be minor variances when measuring the weight percentage of the total surfactant, and the biopesticide may be formed of about 1.00 wt. % to about 50.00 wt. % of surfactant. In still another embodiment, the biopesticide may be formed of 1.00 wt. % to 40.00 wt. % of total surfactant. Again, there may be minor variances when measuring the weight percentage of the total surfactant, and the biopesticide may be formed of about 1.00 wt. % to about 40.00 wt. % of surfactant. In still yet another embodiment, the biopesticide is formed of 2.00 wt. % to 30.00 wt. % of total surfactant. Yet again, there may be minor variances when measuring the weight percentage of the total surfactant, and the biopesticide may be formed of about 2.00 wt. % to about 30.00 wt. % of surfactant. Therefore, in embodiments of the biopesticides disclosed herein, the total amount of surfactant may be as low as 1.00 wt. % and as high as 50.00 wt. % total surfactant (e.g., between 1.00 and 50.00 wt. % total surfactant). In other embodiments, the wt. % of total surfactant may be between about 29-31, 28-32, 27-33, 26-34, 25-35, 24-36, or 22-28.

The following includes non-limiting examples of surfactants which may be suitable for use with the biopesticide compositions described herein. The different kind of surfactants are chosen and comprised in certain ratios in order to obtain a biopesticide composition with certain properties (e.g., soluble in aqueous solution, not harmful to actives, minimal phytotoxic effects, reduced adherence/sticking to formulation applicators/devices, etc.).

The biopesticide compositions described herein may comprise at least one or more anionic surfactants. The anionic surfactant(s) may be either water soluble anionic surfactants, water insoluble anionic surfactants, or a combination of water soluble anionic surfactants and water insoluble anionic surfactants.

Non-limiting examples of water soluble anionic surfactants include alkyl sulfates, alkyl ether sulfates, alkyl amido ether sulfates, alkyl aryl polyether sulfates, alkyl aryl sulfates, alkyl aryl sulfonates, monoglyceride sulfates, alkyl sulfonates, alkyl amide sulfonates, alkyl aryl sulfonates, benzene sulfonates, toluene sulfonates, xylene sulfonates, cumene sulfonates, alkyl benzene sulfonates, alkyl diphenyloxide sulfonate, alpha-olefin sulfonates, alkyl naphthalene sulfonates, paraffin sulfonates, lignin sulfonates, alkyl sulfosuccinates, ethoxylated sulfosuccinates, alkyl ether sulfosuccinates, alkylamide sulfosuccinates, alkyl sulfosuccinamate, alkyl sulfoacetates, alkyl phosphates, phosphate ester, alkyl ether phosphates, acyl sarconsinates, acyl isethionates, N-acyl taurates, N-acyl-N-alkyltaurates, alkyl carboxylates, or a combination thereof.

Commercially available anionic surfactants suitable for the biopesticides described herein include Ninate 60E. In an embodiment, the biopesticide composition comprises Ninate 60E.

The biopesticide compositions described herein may comprise at least one or more nonionic surfactants. The nonionic surfactant(s) may be either water soluble nonionic surfactants, water insoluble nonionic surfactants, or a combination of water soluble nonionic surfactants and water insoluble nonionic surfactants.

Non-limiting examples of water insoluble nonionic surfactants include alkyl and aryl: glycerol ethers, glycol ethers, ethanolamides, sulfoanylamides, alcohols, amides, alcohol ethoxylates, glycerol esters, glycol esters, ethoxylates of glycerol ester and glycol esters, sugar-based alkyl polyglycosides, polyoxyethylenated fatty acids, alkanolamine condensates, alkanolamides, tertiary acetylenic glycols, polyoxyethylenated mercaptans, carboxylic acid esters, polyoxyethylenated polyoxyproylene glycols, sorbitan fatty acid esters, sorbitol ethoxylate esters, or combinations thereof. Also included are EO/PO block copolymers (EO is ethylene oxide, PO is propylene oxide), EO polymers and copolymers, polyamines, and polyvinylpyrrolidones.

Commercially available water insoluble nonionic surfactants that may be suitable for the biopesticide compositions described herein include Tomadol® 91-2.5, Tomadol® 23-1, Tomadol® 23-3, Spann™ 20, Span™ 40, Spann® 60, Spann™ 65, Spann™ 80, Spann™ 85, Arlatone® TV, Atlas® G-1086, Atlas® G-1096, Atlox® 1045A, Cirrasol® G-1086, Cirrasol® G-1096, and combinations thereof.

In one embodiment, the biopesticide compositions described herein comprise at least one water insoluble nonionic surfactant. In another embodiment, the biopesticide compositions described herein comprise at least one water insoluble nonionic surfactant selected from sorbitan fatty acid esters, sorbitol ethoxylate esters and combinations thereof. Non-limiting examples of sorbitan fatty acid esters that may be suitable for the biopesticide compositions described herein include sorbitan monolaurates (e.g., Spann™ 20), sorbitan monopalmitates (e.g., Spann™ 40), sorbitan monostearates (e.g., Spann™ 60), sorbitan tristearates (e.g., Span™ 65), sorbitan monooleates (e.g., Span™ 80), sorbitan trioleates (e.g., Span™ 85), and combinations thereof. Non-limiting examples of sorbitol ethoxylates esters that may be suitable for the biopesticide compositions described herein include polyoxyethylene (40) sorbitol oleates (e.g., Arlatone® TV), polyoxyethylene (40) sorbitol hexaoleates (e.g., Atlas® G-1086, Cirrasol® G-1086), polyoxyethylene (50) sorbitol hexaoleates (e.g., Atlas® G-1096, Cirrasol® G-1096), polyoxyethylene (30) oleate-laurates (e.g., Atlox 1045A), and combinations thereof.

In another particular embodiment, the biopesticide composition comprises one or more sorbitan fatty esters selected from a sorbitan monolaurate, a sorbitan monopalmitate, a sorbitan monostearate, a sorbitan tristearate, a sorbitan monooleate, a sorbitan trioleate, and combinations thereof. In still another particular embodiment, the biopesticide composition comprises one or more sorbitol ethoxylates esters selected from a polyoxyethylene (40) sorbitol oleate, a polyoxyethylene (40) sorbitol hexaoleate, a polyoxyethylene (50) sorbitol hexaoleate, a polyoxyethylene (30) oleate-laurate, and combinations thereof. In yet another particular embodiment, the biopesticide composition comprises at least one sorbitan fatty acid ester, wherein the sorbitan fatty ester is selected from a sorbitan monolaurate, a sorbitan monopalmitate, a sorbitan monostearate, a sorbitan tristearate, a sorbitan monooleate, a sorbitan trioleata, and combinations thereof, and a sorbitol ethoxylate ester, wherein the sorbitol ethoxylates ester is selected from a polyoxyethylene (40) sorbitol oleate, a polyoxyethylene (40) sorbitol hexaoleate, a polyoxyethylene (50) sorbitol hexaoleate, a polyoxyethylene (30) oleate-laurate, and combinations thereof.

In another embodiment, the biopesticide (i.e., composition) comprises a sorbitan monostearate. In still another embodiment, the biopesticide comprises a sorbitan monooleate. In still yet another embodiment, the biopesticide comprises a polyoxyethylene (40) sorbitol hexaoleate. In a particular embodiment, the biopesticide comprises a sorbitan monostearate, a sorbitan monooleate, a polyoxyethylene (40) sorbitol hexaoleate, and combinations thereof. In another particular embodiment, the biopesticide comprises a sorbitan monostearate, a sorbitan monooleate, and combinations thereof. In yet another particular embodiment, the biopesticide comprises a sorbitan monostearate, a polyoxyethylene (40) sorbitol hexaoleate, and combinations thereof. In still another particular embodiment, the biopesticide comprises a sorbitan monooleate, a polyoxyethylene (40) sorbitol hexaoleate, and combinations thereof.

In a particular embodiment, the biopesticide (i.e., composition) comprises Span™ 60. In another particular embodiment, the biopesticide comprises Span™ 80. In still another particular embodiment, the biopesticide comprises a mixture of Span™ 60 and Span™ 80. In yet another particular embodiment, the biopesticide comprises Cirrasol® G-1086. In yet another particular embodiment, the biopesticide comprises Atlas® G-1086. In another particular embodiment, the biopesticide comprises a mixture of Cirrasol® G-1086 and Atlas® G-1086. In still yet another particular embodiment, the biopesticide comprises a mixture of Cirrasol® G-1086 and Spann™ 60. In another particular embodiment, the biopesticide comprises a mixture of Cirrasol® G-1086 and Span™ 80. In still yet another particular embodiment, the biopesticide comprises a mixture of Atlas® G-1086 and Span™ 60. In yet another particular embodiment, the biopesticide comprises a mixture of Atlas® G-1086 and Span™ 80. In another particular embodiment, the biopesticide comprises a mixture of Cirrasol® G-1086, Span™ 60, and Span™ 80. In still another particular embodiment, the biopesticide comprises a mixture of Atlas® G-1086, Spann™ 60, and Spann™ 80. In still yet another particular embodiment, the biopesticide comprises a mixture of Atlas® G-1086, Cirrasol® G-1086, and Span™ 60. In yet another particular embodiment, the biopesticide comprises a mixture of Atlas® G-1086, Cirrasol® G-1086, and Span™ 80. In yet still another particular embodiment, the biopesticide comprises a mixture of Atlas® G-1086, Cirrasol® G-1086, and Span™ 60, and Span™ 80.

In a particular embodiment, the biopesticide composition comprises at least one sorbitan fatty acid ester and at least sorbitol ethoxylate ester wherein the ratio of sorbitan fatty acid ester to sorbitol ethoxylate ester is between 1:100 to 100:1. In a more particular embodiment, the ratio of sorbitan fatty acid ester to sorbitol ethoxylate ester is between 1:90 to 90:1. In another embodiment, the ratio of sorbitan fatty acid ester to sorbitol ethoxylate ester is between 1:80 to 80:1. In still another embodiment, the ratio of sorbitan fatty acid ester to sorbitol ethoxylate ester is between 1:70 to 70:1. In still yet another embodiment, the ratio of sorbitan fatty acid ester to sorbitol ethoxylate ester is between 1:60 to 60:1. In another embodiment, the ratio of sorbitan fatty acid ester to sorbitol ethoxylate ester is between 1:50 to 50:1. In still another embodiment, the ratio of sorbitan fatty acid ester to sorbitol ethoxylate ester is between 1:40 to 40:1. In yet another embodiment, the ratio of sorbitan fatty acid ester to sorbitol ethoxylate ester is between 1:30 to 30:1. In still yet another embodiment, the ratio of sorbitan fatty acid ester to sorbitol ethoxylate ester is between 1:20 to 20:1. In another embodiment, the ratio of sorbitan fatty acid ester to sorbitol ethoxylate ester is between 1:10 to 10:1. In still another embodiment, the ratio of sorbitan fatty acid ester to sorbitol ethoxylate ester is 1:1.

In a particular embodiment, the ratio of sorbitan fatty acid ester to sorbitol ethoxylate ester is 5:95 or 95:5. In another particular embodiment, the ratio of sorbitan fatty acid ester to sorbitol ethoxylate ester is 10:90 or 90:10. In still another particular embodiment, the ratio of sorbitan fatty acid ester to sorbitol ethoxylate ester is 7.5:92.5 or 92.5:7.5. In still yet another a particular embodiment, the ratio of sorbitan fatty acid ester to sorbitol ethoxylate ester is 15:85 or 85:15.

In a particular embodiment, the biopesticide composition comprises at least one sorbitan monooleate and at least one polyoxyethylene (40) sorbitol hexaoleate wherein the ratio of sorbitan monooleate to polyoxyethylene (40) sorbitol hexaoleate is between 1:100 to 100:1. In a more particular embodiment, the ratio of sorbitan monooleate to polyoxyethylene (40) sorbitol hexaoleate is between 1:90 to 90:1. In another embodiment, the ratio of sorbitan monooleate to polyoxyethylene (40) sorbitol hexaoleate is between 1:80 to 80:1. In still another embodiment, the ratio of sorbitan monooleate to polyoxyethylene (40) sorbitol hexaoleate is between 1:70 to 70:1. In still yet another embodiment, the ratio of sorbitan monooleate to polyoxyethylene (40) sorbitol hexaoleate is between 1:60 to 60:1. In another embodiment, the ratio of sorbitan monooleate to polyoxyethylene (40) sorbitol hexaoleate is between 1:50 to 50:1. In still another embodiment, the ratio of sorbitan monooleate to polyoxyethylene (40) sorbitol hexaoleate is between 1:40 to 40:1. In yet another embodiment, the ratio of sorbitan monooleate to polyoxyethylene (40) sorbitol hexaoleate is between 1:30 to 30:1. In still yet another embodiment, the ratio of sorbitan monooleate to polyoxyethylene (40) sorbitol hexaoleate is between 1:20 to 20:1. In another embodiment, the ratio of sorbitan monooleate to polyoxyethylene (40) sorbitol hexaoleate is between 1:10 to 10:1. In still another embodiment, the ratio of sorbitan monooleate to polyoxyethylene (40) sorbitol hexaoleate is 1:1.

In a particular embodiment, the ratio of sorbitan monooleate to polyoxyethylene (40) sorbitol hexaoleate is 5:95 or 95:5. In another particular embodiment, the ratio of sorbitan monooleate to polyoxyethylene (40) sorbitol hexaoleate is 10:90 or 90:10. In still another particular embodiment, the ratio of sorbitan monooleate to polyoxyethylene (40) sorbitol hexaoleate is 7.5:92.5 or 92.5:7.5. In still yet another particular embodiment, the ratio of sorbitan monooleate to polyoxyethylene (40) sorbitol hexaoleate is 15:85 or 85:15.

In particular embodiments, the ratio of sorbitan monooleate or sorbitan monooleate, to polyoxyethylene (40) sorbitol hexaoleate may be 0.01, 0.02, 0.03, 0.04, 0.05, 0.06, 0.07, 0.08, 0.09, 0.10, 0.11, 0.12, 0.13, 0.14, 0.15, 0.20, 0.25, 0.30, and the like.

In a particular embodiment, the biopesticide composition comprises at least one Span™ 80 and at least one Cirrasol® G-1086 wherein the ratio of Span™ 80 to Cirrasol® G-1086 is between 1:100 to 100:1. In a more particular embodiment, the ratio of Span™ 80 to Cirrasol® G-1086 is between 1:90 to 90:1. In another embodiment, the ratio of Span™ 80 to Cirrasol® G-1086 is between 1:80 to 80:1. In still another embodiment, the ratio of Span™ 80 to Cirrasol® G-1086 is between 1:70 to 70:1. In still yet another embodiment, the ratio of Span™ 80 to Cirrasol® G-1086 is between 1:60 to 60:1. In another embodiment, the ratio of Span™ 80 to Cirrasol® G-1086 is between 1:50 to 50:1. In still another embodiment, the ratio of Span™ 80 to Cirrasol® G-1086 is between 1:40 to 40:1. In yet another embodiment, the ratio of Span™ 80 to Cirrasol® G-1086 is between 1:30 to 30:1. In still yet another embodiment, the ratio of Span™ 80 to Cirrasol® G-1086 is between 1:20 to 20:1. In another embodiment, the ratio of Spann™ 80 to Cirrasol® G-1086 is between 1:10 to 10:1. In still another embodiment, the ratio of Span™ 80 to Cirrasol® G-1086 is 1:1.

In a particular embodiment, the ratio of Span™ 80 to Cirrasol® G-1086 is 5:95 or 95:5. In another particular embodiment, the ratio of Span™ 80 to Cirrasol® G-1086 is 10:90 or 90:10. In still another particular embodiment, the ratio of Span™ 80 to Cirrasol® G-1086 is 7.5:92.5 or 92.5:7.5. In still yet another particular embodiment, the ratio of Span™ 80 to Cirrasol® G-1086 is 15:85 or 85:15.

In particular embodiments, the ratio of Span™ 60 or Span™ 80, to Cirrasol® G-1086 may be 0.01, 0.02, 0.05, 0.10, 0.15, 0.20, 0.25, 0.30, 0.35, 0.40, 0.45 and the like.

Non-limiting examples of water soluble nonionic surfactants include sorbitan fatty acid alcohol ethoxylates and sorbitan fatty acid ester ethoxylates. In one embodiment, the biopesticide composition comprises at least one water soluble nonionic surfactant that is a linear primary, or secondary or branched alcohol ethoxylate having the formula: RO(CH₂CH₂O)ₙH, wherein R is the hydrocarbon chain length and n is the average number of moles of ethylene oxide. In an embodiment, R can be a linear primary, or secondary, or branched alcohol ethoxylates having a hydrocarbon chain length in the range from C9 to C16 and n ranges from 6 to 13. In another embodiment, the biopesticide composition comprises at least one alcohol ethoxylate where R is linear C9-C11 hydrocarbon chain length, and n is 6. In still another embodiment, when the biopesticides composition described herein comprise more than one water soluble surfactant, the water soluble surfactants are of substantially the same carbon chain length.

Commercially available water soluble nonionic surfactants that may be suitable for the biopesticides described herein include Tomadol® 9-11, Tomadol® 23-7, Tomadol® 91-6, Tween® 20, Tween® 21, Tween® 40, Tween® 60, Tween® 80, Surfonic L24-4, and combinations thereof.

In one embodiment, the biopesticide compositions described herein comprise at least one water soluble nonionic surfactant selected from the group consisting of Tomadol® 9-11, Tomadol® 23-7, Tomadol® 91-6, and combinations thereof.

In a particular embodiment, the biopesticide compositions described herein comprise at least one sorbitan fatty acid ester ethoxylate selected from the group consisting of Tween® 20, Tween® 21, Tween® 40, Tween® 60, Tween® 80, Surfonic L24-4, and combinations thereof.

In still another embodiment, the biopesticide compositions described herein comprise at least one alcohol ethoxylate, at least one sorbitan fatty acid ester ethoxylate, or a combination thereof. In still another embodiment, the biopesticide compositions described herein comprise at least one water soluble nonionic surfactant selected from the group consisting of Tomadol® 9-11, Tomadol® 23-7, Tomadol® 91-6, Tween® 20, Tween® 21, Tween® 40, Tween® 60, Tween® 80, Surfonic L24-4, and combinations thereof.

In a particular embodiment, the biopesticide composition comprises Surfonic L24-4.

In one embodiment, the biopesticide compositions described herein comprise one or more nonionic surfactants. In another embodiment, the biopesticide compositions comprise one or more water insoluble nonionic surfactants. In still another embodiment, the biopesticide compositions comprise one or more water insoluble nonionic surfactants and one or more water soluble nonionic surfactants.

In another embodiment, the biopesticide compositions described herein may also comprise silicone-based antifoams used as surfactants in silicone-based and mineral-oil based antifoams.

In another embodiment, the biopesticide compositions described herein may also comprise alkali metal salts of fatty acids (e.g., water soluble alkali metal salts of fatty acids and/or water insoluble alkali metal salts of fatty acids) of greater than 10 carbons in length. In an embodiment, biopesticide compositions comprising alkali metal salts of fatty acids comprise carbon chains greater than or equal to 18 carbons in length. In still another embodiment, biopesticide compositions comprising alkali metal salts of fatty acids comprise carbon chains greater than or equal to 20 carbons in length.

### Optional Ingredients:

Examples of optional ingredients to be included in the biopesticide composition to be used in step (b) of the method according to the first aspect of this invention are given herein below.

The biopesticides (i.e., the compositions described herein) may further comprise one or more optional ingredients that are physically and/or chemically compatible with the biopesticides embodied herein. Non-limiting optional ingredients include anti-settling agents, agriculturally beneficial ingredients (e.g., enzymes, beneficial microorganisms, insecticides, fungicides, nematicides, nutrients, etc.), insect growth regulators, electrostatic carriers, preservatives, fillers, pH adjusting agents, stabilizers, builders, buffers, antioxidants, water absorbing agents, foams, humectants, wetting agents UV protectants, solvents, nutritive additives, and combinations thereof. Such ingredients are known to those skilled in the art.

In at least one embodiment, the biopesticides (i.e., compositions described herein) may optionally comprise one or more anti-settling agents. Alternatively, the one or more anti-settling agents may be applied either simultaneously or applied sequentially, with the biopesticides disclosed herein. The one or more anti-settling agents may comprise any agent capable of maintaining insoluble particles (i.e., fungal pesticide spores) uniformly suspended in liquid solution (i.e., prevent insoluble from settling).

In embodiments, the biopesticide (i.e., the composition), may be formed of 0.01 wt. % to 10.00 wt. % of anti-settling agent. There may be minor variances when measuring the weight percentage of the anti-settling agent and the biopesticide may be formed of about 0.01 wt. % to about 10.00 wt. % of anti-settling agent. In still another embodiment, the biopesticide may be formed of 0.01 wt. % to 5.00 wt. % of anti-settling agent. Again, there may be minor variances when measuring the weight percentage of the anti-settling agent and the biopesticide may be formed of about 0.01 wt. % to about 5.00 wt. % of anti-settling agent. In still yet another embodiment, the biopesticide is formed of 0.01 wt. % to 2.00 wt. % of anti-settling agent. Yet again, there may be minor variances when measuring the weight percentage of the anti-settling agent and the biopesticide may be formed of about 0.01 wt. % to about 2.00 wt. % of anti-settling agent. Therefore, in embodiments of the biopesticides disclosed herein, the total amount of anti-settling agent may be as low as 1.00 wt. % and as high as 50.00 wt. % anti-settling agent (e.g., between 1.00 and 50.00 wt. % anti-settling agent).

Non-limiting examples of anti-settling agents that may be suitable for the biopesticides described herein polyvinyl acetate, polyvinyl alcohols with different degrees of hydrolysis, polyvinylpyrrolidones, polyacrylates, acrylate-, polyol- or polyester-based paint system binders which are soluble or dispersible in water, moreover copolymers of two or more monomers such as acrylic acid, methacrylic acid, itaconic acid, maleic acid, fumaric acid, maleic anhydride, vinylpyrrolidone, ethylenically unsaturated monomers such as ethylene, butadiene, isoprene, chloroprene, styrene, divinylbenzene, ot-methylstyrene or p-methylstyrene, further vinyl halides such as vinyl chloride and vinylidene chloride, additionally vinyl esters such as vinyl acetate, vinyl propionate or vinyl stearate, moreover vinyl methyl ketone or esters of acrylic acid or methacrylic acid with monohydric alcohols or polyols such as methyl acrylate, methyl methacrylate, ethyl acrylate, ethylene methacrylate, lauryl acrylate, lauryl methacrylate, decyl acrylate, N, N-dimethylamino-ethyl methacrylate, 2-hydroxyethyl methacrylate, 2-hydroxypropyl methacrylate or glycidyl methacrylate, furthermore diethyl esters or monoesters of unsaturated dicarboxylic acids, furthermore (meth)acrylamido-N-methylol methyl ether, amides or nitriles such as acrylamide, methacrylamide, N-methylol(meth)acrylamide, acrylonitrile, methacrylonitrile, and also N-substituted maleiraides and ethers such as vinyl butyl ether, vinyl isobutyl ether or vinyl phenyl ether, and combinations thereof. In another embodiment, the gelling agents which may be used include hydrophobically-modified clays (e.g., sodium montmorillonite where exchangeable sodium ions are replaced with organic cationic molecules, such as, alkylamines), surface modified silicas, fumed silicas (e.g., untreated, or surface-modified), and combinations thereof. Commercially available untreated fumed silicas include CAB-O-SIL® M-5, CAB-O-SIL® M-7D, CAB-O-SIL® MS-75D PDS, CAB-O-SIL® S-17D, CAB-O-SIL® EH-5, CAB-O-SIL® H-300, CAB-O-SIL® H-5, CAB-O-SIL® LM-150, CAB-O-SIL® MS-35, etc. (available from Cabot Corporation, Tuscola, Ill.). Surface-modified fumed silicas include, for example, fumed silicas surface-modified with hexamethyldisilazane, dimethyldichlorosilane (DiMeDi), polydimethylsiloxane, etc. Non-limiting examples of commercially available surface-modified fumed silicas include CAB-O-SIL® TS-530, CAB-O-SIL® TS-530D, CAB-O-SIL® TS-610, CAB-O-SIL® TS-622, CAB-O-SIL® TS-720, etc. (available from Cabot Corporation, Tuscola, Ill.).

In at least one embodiment, the biopesticides (i.e., compositions described herein) may optionally comprise one or more enzymes. Alternatively, the one or more enzymes may be applied either simultaneously or applied sequentially, with the biopesticides disclosed herein.

### Applications Rates and Dilutions

Examples of application rates and dilution to be used in step (b) of the method according to the first aspect of this invention are given herein below.

The biopesticides described herein may be applied at varying concentrations to the poultry. In an embodiment, the biopesticides are diluted with water. In a particular embodiment, the biopesticide is diluted with water at a rate of 0.01 to 5.00 g of biopesticide to 95.00 g to 99.99 g of water.

In a particular embodiment, the biopesticide is diluted with water at a rate of 5.00 g of biopesticide to 95.00 g of water. In another particular embodiment, the biopesticide is diluted with water at a rate of 4.00 g of biopesticide to 96.00 g of water. In still another particular embodiment, the biopesticide is diluted with water at a rate of 3.00 g of biopesticide to 97.00 g of water. In yet another particular embodiment, the biopesticide is diluted with water at a rate of 2.00 g of biopesticide to 98.00 g of water. In still yet another particular embodiment, the biopesticide is diluted with water at a rate of 1.00 g of biopesticide to 99.00 g of water. In yet still another particular embodiment, the biopesticide is diluted with water at a rate of 0.90 g of biopesticide to 99.10 g of water. In another particular embodiment, the biopesticide is diluted with water at a rate of 0.80 g of biopesticide to 99.20 g of water. In still another particular embodiment, the biopesticide is diluted with water at a rate of 0.70 g of biopesticide to 99.30 g of water. In yet another particular embodiment, the biopesticide is diluted with water at a rate of 0.60 g of biopesticide to 99.40 g of water. In still yet another particular embodiment, the biopesticide is diluted with water at a rate of 0.50 g of biopesticide to 99.50 g of water. In yet still another embodiment, the biopesticide is diluted with water at a rate of 0.40 g of biopesticide to 99.60 g of water. In another particular embodiment, the biopesticide is diluted with water at a rate of 0.35 g of biopesticide to 99.65 g of water. In still another particular embodiment, the biopesticide is diluted with water at a rate of 0.30 g of biopesticide to 99.70 g of water. In yet another particular embodiment, the biopesticide is diluted with water at a rate of 0.25 g of biopesticide to 99.75 g of water. In still yet another particular embodiment, the biopesticide is diluted with water at a rate of 0.20 g of biopesticide to 99.80 g of water. In yet still another particular embodiment, the biopesticide is diluted with water at a rate of 0.15 g of biopesticide to 99.85 g of water. In another particular embodiment, the biopesticide is diluted with water at a rate of 0.10 g of biopesticide to 99.90 g of water. In still another particular embodiment, the biopesticide is diluted with water at a rate of 0.05 g of biopesticide to 99.95 g of water. In yet another particular embodiment, the biopesticide is diluted with water at a rate of 0.01 g of biopesticide to 99.99 g of water.

Use of Metarhizium anisopliae Strain F52 for Controlling of Insect Pests on Poultry

In a second aspect the invention relates to use of Metarhizium anisopliae strain F52 (also known as Metarhizium anisopliae strain 52, Metarhizium anisopliae strain 7, Metarhizium anisopliae strain 43, Metarhizium anisopliae BIO-1020, TAE-001, MET52® and previously deposited as DSM 3884, DSM 3885, ATCC 90448, SD 170, and ARSEF 7711; available from Novozymes Biologicals, Inc., USA) for controlling of insect pests on poultry. The invention relates in one embodiment to use of the Metarhizium anisopliae strain having the deposit accession number NRRL 67280; a strain having all of the identifying characteristics of the Metarhizium anisopliae strain having the deposit accession number NRRL 67280 or a mutant thereof for controlling of insect pests on poultry. The Metarhizium anisopliae strain is in one embodiment in spore form.

The poultry is in one embodiment selected from the group consisting of Galloanserae, Anatidae, Galliformes, Anseriformes chickens, guineafowls, quails, turkeys, ducks and geese. In another embodiment, the poultry is selected from broilers and layers. In a preferred embodiment, the insect pest is an insect selected from the group consisting of mites, fleas, louse, ticks and bugs. In a more specific embodiment, the insect pest is an insect selected from the group consisting of Northern fowl mites (Ornithonyssus sylviarum), Red Mite (Dermanyssus gallinae), Chicken Flea (Ceratophyllus Gallinae), Scaly-leg mites (Knemidokoptes mutans), Sticktight fleas (Echidnophaga gallinacea), chicken body louse (Menacanthus stramineus), shaft louse (Menopon gallinae), Chicken mites (Dermanyssus gallinae), Fowl ticks (Argas persicus), and Bedbugs (Cimex lectularius).

A biopesticide composition for controlling insect pests on poultry

In a third aspect the invention relates to a biopesticide composition having an effective amount of one or more entomopathogenic fungi, such as, e.g., Metarhizium spp., for controlling insect pests on poultry. The biopesticide composition is applied to the outer surface of the poultry, preferably, by spraying—i.e., it is sprayed onto the poultry. Entomopathogenic fungi include Metarhizium spp., Beauveria spp., Paecilomyces spp, Lecanicillium spp., and Hirsutella spp. In one embodiment, the entomopathogenic fungi is Metarhizium spp. In a preferred embodiment, the entomopathogenic fungus is Metarhizium anisopliae or Metarhizium brunneum. In another preferred embodiment, the entomopathogenic fungus is Metarhizium anisopliae. In another preferred embodiment, the entomopathogenic fungus is Metarhizium brunneum. In an even more preferred embodiment, the entomopathogenic fungus is Metarhizium anisopliae strain F52 (also known as Metarhizium anisopliae strain 52, Metarhizium anisopliae strain 7, Metarhizium anisopliae strain 43, Metarhizium anisopliae BIO-1020, TAE-001, MET52® and previously deposited as DSM 3884, DSM 3885, ATCC 90448, SD 170, and ARSEF 7711; available from Novozymes Biologicals, Inc., USA). In an even more preferred embodiment, the entomopathogenic fungus is the Metarhizium anisopliae strain having the deposit accession number NRRL 67280; a strain having all of the identifying characteristics of Metarhizium anisopliae strain having the deposit accession number NRRL 67280 or a mutant thereof. The entomopathogenic fungus such as e.g. Metarhizium spp. can be in spore form.

The biopesticide composition can be, e.g., in a liquid form, a semi-solid form or in a solid form such as in a powder form. The biopesticide composition can in an embodiment further comprises at least one surfactant and at least one carrier.

The third aspect comprises in one embodiment that the biopesticide composition is sprayed onto the poultry once. In another embodiment, the spraying is performed more than once such as 2, 3, 4, 5, 6, 7, 8, 9, 10 or more than 10 times. In a preferred embodiment, the administering/spraying comprises addition of a dosage from 1×10⁴ to 1×10⁷ conidia of the entomopathogenic fungi such as e.g. Metarhizium spp. per square cm poultry surface.

The biopesticide composition preferably leads to a reduction of the number of the one or more types of insects on the poultry. Preferably, the number of one or more types of insects on the poultry is reduced by at least 5%, such as at least 10%, for example by at least 15%, such as by at least 20%, for example by at least 25%, such as by at least 30%, for example by at least 35%, such as by at least 40%, for example by at least 45%, such as by at least 50%, for example by at least 55%, such as by at least 60%, for example by at least 65%, such as by at least 70%, for example by at least 75%, such as by at least 80%, for example by at least 85%, such as by at least 90%, for example by at least 95%, such as by at least 99%, or for example by 100%. In one embodiment, the number of one or more types of insects on the poultry is reduced by at least 5%, such as at least 10%, for example by at least 15%, such as by at least 20%, for example by at least 25%, such as by at least 30%, for example by at least 35%, such as by at least 40%, for example by at least 45%, such as by at least 50%, for example by at least 55%, such as by at least 60%, for example by at least 65%, such as by at least 70%, for example by at least 75%, such as by at least 80%, for example by at least 85%, such as by at least 90%, for example by at least 95%, such as by at least 99%, or for example by 100% determined 24 hours, 48 hours, 72 hours or 96 hours after the administration. In another embodiment, the controlling of insect pests partly or completely exterminates insects of one or more types on the poultry. Preferably, the controlling of insect pests partly or completely exterminates insects of one or more types on the poultry determined 24 hours, 48 hours, 72 hours or 96 hours after the administration.

In a preferred embodiment, the poultry is selected from the group consisting of Galloanserae, Anatidae, Galliformes, Anseriformes chickens, Guineafowls, quails, turkeys, ducks and geese. In another embodiment, the poultry is selected from broilers and layers.

In a preferred embodiment, the insect pest is selected from an insect of the group consisting of mites, fleas, flies, louse, ticks and bugs. In a more specific embodiment, the insect pest is selected from the group consisting of Northern fowl mites (Ornithonyssus sylviarum), Red Mite (Dermanyssus gallinae), Chicken Flea (Ceratophyllus Gallinae), Scaly-leg mites (Knemidokoptes mutans), Sticktight fleas (Echidnophaga gallinacea), chicken body louse (Menacanthus stramineus), shaft louse (Menopon gallinae), Chicken mites (Dermanyssus gallinae), Fowl ticks (Argas persicus), and Bedbugs (Cimex lectularius).

In another embodiment, the biopesticide composition having an effective amount of one or more entomopathogenic fungi such as e.g. Metarhizium spp. further comprises a chemical pesticide.

### PREFERRED EMBODIMENTS

Preferred embodiments of the invention are described in the set of items herein below.

1. A method for controlling an insect pest on poultry comprising:

(a) preparing a biopesticide composition having an effective amount of one or more entomopathogenic fungi; and

(b) spraying said biopesticide composition onto the poultry.

2. The method of item 1, wherein the entomopathogenic fungi is selected from the group consisting of Metarhizium spp., Beauveria spp., Paecilomyces spp, Lecanicillium spp., and Hirsutella spp.
3. The method of item 1, wherein the entomopathogenic fungi is Metarhizium spp.
4. The method of item 3, wherein said entomopathogenic fungus is Metarhizium anisopliae or Metarhizium brunneum.
5. The method of item 3, wherein said entomopathogenic fungus is Metarhizium anisopliae.
6. The method of item 3, wherein said entomopathogenic fungus is Metarhizium brunneum.
7. The method of item 3, wherein said entomopathogenic fungus is Metarhizium anisopliae strain F52 (also known as Metarhizium anisopliae strain 52, Metarhizium anisopliae strain 7, Metarhizium anisopliae strain 43, Metarhizium anisopliae BIO-1020, TAE-001, MET52® and previously deposited as DSM 3884, DSM 3885, ATCC 90448, SD 170, and ARSEF 7711; available from Novozymes Biologicals, Inc., USA).
8. The method of item 3, wherein said entomopathogenic fungus is Metarhizium anisopliae strain having the deposit accession number NRRL 67280; a strain having all of the identifying characteristics of Metarhizium anisopliae strain having the deposit accession number NRRL 67280 or a mutant thereof.
9. The method of any of the previous items, wherein the entomopathogenic fungus such as Metarhizium spp is in spore form.
10. The method of any of the previous items, wherein the biopesticide composition is in a liquid form.
11. The method of any of the previous items, wherein the biopesticide composition is in a semi-solid form.
12. The method of any of the previous items, wherein the biopesticide composition is in a solid form such as in a powder form.
13. The method of any of the previous items, wherein the biopesticide composition further comprises at least one surfactant and at least one carrier.
14. The method of item 13, wherein the at least one surfactant comprises at least one sorbitan fatty acid surfactant, at least one sorbitol ethoxylate ester surfactant or a mixture of any of these.
15. The method of item 13, wherein the at least one surfactant comprises a sorbitan monostearate, a polyoxyethylene sorbitol hexaoleate, a sorbitan monooleate or a mixture of any of these.
16. The method of item 13, wherein the at least one surfactant comprises a mixture of a sorbitan monostearate and a polyoxyethylene sorbitol hexaoleate, or a mixture of a sorbitan monooleate and a polyoxyethylene sorbitol hexaoleate.
17. The method of any of items 13-16, where the sorbitan monostearate includes Span™ 60 and the sorbitan monooleate includes Span™ 80.
18. The method of any of items 13-16, where the polyoxyethylene sorbitol hexaoleate includes a polyoxyethylene (40) sorbitol hexaoleate.
19. The method of item 18, where the polyoxyethylene (40) sorbitol hexaoleate includes Cirrasol® G-1086.
20. The method of any of items 13-19, where the total amount of surfactant is between at least one of about 1 to about 50 wt. %, about 2 to about 30 wt. %, about 24 to about 36 wt. %, about 27 to about 33 wt. %, and about 29 to about 31 wt. %.
21. The method of any of items 13-19, where the total amount of sorbitan fatty acid surfactant is between about 0.5 to about 7.5 wt. % and the total amount of sorbitol ethoxylate ester surfactant is between about 7.5 to about 30 wt. %.
22. The method of any of items 13-21, where the ratio of the sorbitan fatty acid surfactant to the ethoxylate ester surfactant is between about 0.02 to 1 to about 0.25 to 1.
23. The method of any of items 13-22, where the total amount of surfactant is about 30 wt. %, the sorbitan fatty acid surfactant includes a sorbitan monooleate, the sorbitol ethoxylate ester surfactant includes a polyoxyethylene (40) sorbitol hexaoleate, and the ratio between the sorbitan monooleate and the polyoxyethylene (40) sorbitol hexaoleate is about 0.08 to 1.
24. The method of any one of items 13-23, wherein the at least one carrier comprises one or more paraffinic oils.
25. The method of any one of items 13-23, wherein the at least one carrier comprises SunSpray 6N oil (available from Sunoco, Petronas Lubricants, Belgium Nev.).
26. The method of any one of items 13-25, wherein the biopesticide composition further comprises an anti-settling agent.
27. The method of any one of items 13-25, wherein the biopesticide composition further comprises an anti-settling agent, wherein the anti-settling agent comprises a fumed silica.
28. The method of any of the previous items, wherein the spraying is performed once.
29. The method of any of the previous items, wherein the spraying is performed more than once such as 2, 3, 4, 5, 6, 7, 8, 9, 10 or more than 10 times.
30. The method of any of the previous items, wherein the administering comprises addition of a dosage from 1×10⁴ to 1×10⁷ conidia of the entomopathogenic fungi per square cm poultry surface.
31. The method of any of the previous items, wherein the controlling of an insect pest reduces the number of one or more types of insects on the poultry.
32. The method of item 31, where the number of one or more types of insects on the poultry is reduced by at least 5%, such as at least 10%, for example by at least 15%, such as by at least 20%, for example by at least 25%, such as by at least 30%, for example by at least 35%, such as by at least 40%, for example by at least 45%, such as by at least 50%, for example by at least 55%, such as by at least 60%, for example by at least 65%, such as by at least 70%, for example by at least 75%, such as by at least 80%, for example by at least 85%, such as by at least 90%, for example by at least 95%, such as by at least 99%, or for example by 100%.
33. The method of item 31, wherein the number of one or more types of insects on the poultry is reduced by at least 5%, such as at least 10%, for example by at least 15%, such as by at least 20%, for example by at least 25%, such as by at least 30%, for example by at least 35%, such as by at least 40%, for example by at least 45%, such as by at least 50%, for example by at least 55%, such as by at least 60%, for example by at least 65%, such as by at least 70%, for example by at least 75%, such as by at least 80%, for example by at least 85%, such as by at least 90%, for example by at least 95%, such as by at least 99%, or for example by 100% determined 24 hours, 48 hours, 72 hours or 96 hours after the administration.
34. The method of any of the previous items, wherein the controlling of an insect pest partly or completely exterminates insects of one or more types on the poultry.
35. The method of item 34, wherein the controlling of an insect pest partly or completely exterminates insects of one or more types on the poultry determined 24 hours, 48 hours, 72 hours or 96 hours after the administration.
36. The method of any of the previous items, wherein the poultry is selected from the group consisting of Galloanserae, Anatidae, Galliformes, Anseriformes chickens, Guineafowls, quails, turkeys, ducks and geese.
37. The method of any of the previous items, wherein the poultry is selected from broilers and layers.
38. The method of any of the previous items, wherein the insect pest is selected from an insect of the group consisting of mites, fleas, flies, louse, ticks and bugs.
39. The method of any of the previous items, wherein the insect pest is an insect selected from the group consisting of Northern fowl mites (Ornithonyssus sylviarum), Red Mite (Dermanyssus gallinae), Chicken Flea (Ceratophyllus Gallinae), Scaly-leg mites (Knemidokoptes mutans), Sticktight fleas (Echidnophaga gallinacea), chicken body louse (Menacanthus stramineus), shaft louse (Menopon gallinae), Chicken mites (Dermanyssus gallinae), Fowl ticks (Argas persicus), and Bedbugs (Cimex lectularius).
40. The method of any of the previous items, wherein the biopesticide composition having an effective amount of one or more entomopathogenic fungi further comprises a chemical pesticide.
41. The method of any of the previous items, wherein the method further comprises administration of a chemical pesticide to the poultry.
42. The method of item 41, wherein the administration of a chemical pesticide to the poultry is performed either before, after or simultaneously with step (b) in item 1.
43. The method of item 41 or 42, wherein said chemical pesticide is a bait formulation, a sprayable formulation, and a dustable formulation.
44. The method of any of items 41-43, wherein said chemical pesticide includes an active ingredient, said active ingredient being selected from the group consisting of boric acid, abamectin, fipronil, hydramethylnon, indoxacarb, and imidacloprid.
45. Use of Metarhizium anisopliae strain F52 (also known as Metarhizium anisopliae strain 52, Metarhizium anisopliae strain 7, Metarhizium anisopliae strain 43, Metarhizium anisopliae BIO-1020, TAE-001, MET52® and previously deposited as DSM 3884, DSM 3885, ATCC 90448, SD 170, and ARSEF 7711; available from Novozymes Biologicals, Inc., USA) for controlling of an insect pest on poultry.
46. Use of Metarhizium anisopliae strain having the deposit accession number NRRL 67280; a strain having all of the identifying characteristics of Metarhizium anisopliae strain having the deposit accession number NRRL 67280 or a mutant thereof for controlling of an insect pest on poultry.
47. Use of item 45 or 46 wherein the Metarhizium anisopliae or the Metarhizium brunneum strain is in spore form.
48. Use of any of items 45-47 wherein the poultry is selected from the group consisting of Galloanserae, Anatidae, Galliformes, Anseriformes chickens, guineafowls, quails, turkeys, ducks and geese.
49. Use of any of items 45-48 wherein the poultry is selected from broilers and layers.
50. Use of any of items 45-49 wherein the insect pest is an insect selected from the group consisting of mites, fleas, louse, ticks and bugs.
51. Use of any of items 45-49 wherein the insect pest is an insect selected from the group consisting of Northern fowl mites (Ornithonyssus sylviarum), Red Mite (Dermanyssus gallinae), Chicken Flea (Ceratophyllus Gallinae), Scaly-leg mites (Knemidokoptes mutans), Sticktight fleas (Echidnophaga gallinacea), chicken body louse (Menacanthus stramineus), shaft louse (Menopon gallinae), Chicken mites (Dermanyssus gallinae), Fowl ticks (Argas persicus), and Bedbugs (Cimex lectularius).
52. A biopesticide composition having an effective amount of one or more entomopathogenic fungi for controlling an insect pest on poultry.
53. The biopesticide composition of item 52, wherein the biopesticide composition is sprayed onto the poultry.
54. The biopesticide composition of item 52 or 53, wherein the entomopathogenic fungi is selected from the group consisting of Metarhizium spp., Beauveria spp., Paecilomyces spp, Lecanicillium spp., and Hirsutella spp.
55. The biopesticide composition of any of items 52-54, wherein said entomopathogenic fungus is Metarhizium anisopliae or Metarhizium brunneum.
56. The biopesticide composition of any of items 52-54, wherein said entomopathogenic fungus is Metarhizium anisopliae.
57. The biopesticide composition of any of items 52-54, wherein said entomopathogenic fungus is Metarhizium brunneum.
58. The biopesticide composition of any of items 52-54, wherein said entomopathogenic fungus is Metarhizium anisopliae strain F52 (also known as Metarhizium anisopliae strain 52, Metarhizium anisopliae strain 7, Metarhizium anisopliae strain 43, Metarhizium anisopliae BIO-1020, TAE-001, MET52® and previously deposited as DSM 3884, DSM 3885, ATCC 90448, SD 170, and ARSEF 7711; available from Novozymes Biologicals, Inc., USA).
59. The biopesticide composition of any of items 52-54, wherein said entomopathogenic fungus is Metarhizium anisopliae strain having the deposit accession number NRRL 67280; a strain having all of the identifying characteristics of Metarhizium anisopliae strain having the deposit accession number NRRL 67280 or a mutant thereof.
60. The biopesticide composition of any of items 52-59, wherein the entomopathogenic fungus such as the Metarhizium spp. is in spore form.
61. The biopesticide composition of any of items 52-60, wherein the biopesticide composition is in a liquid form.
62. The biopesticide composition of any of items 52-60, wherein the biopesticide composition is in a semi-solid form.
63. The biopesticide composition of any of items 52-60, wherein the biopesticide composition is in a solid form such as in a powder form.
64. The biopesticide composition of any of items 52-63, wherein the biopesticide composition further comprises at least one surfactant and at least one carrier.
65. The biopesticide composition of item 64, wherein the at least one surfactant comprises at least one sorbitan fatty acid surfactant, at least one sorbitol ethoxylate ester surfactant or a mixture of any of these.
66. The biopesticide composition of item 64, wherein the at least one surfactant comprises a sorbitan monostearate, a polyoxyethylene sorbitol hexaoleate, a sorbitan monooleate or a mixture of any of these.
67. The biopesticide composition of item 64, wherein the at least one surfactant comprises a mixture of a sorbitan monostearate and a polyoxyethylene sorbitol hexaoleate, or a mixture of a sorbitan monooleate and a polyoxyethylene sorbitol hexaoleate.
68. The biopesticide composition of any of items 64-67, wherein the sorbitan monostearate includes Span™ 60 and the sorbitan monooleate includes Span™ 80.
69. The biopesticide composition of any of items 64-67, wherein the polyoxyethylene sorbitol hexaoleate includes a polyoxyethylene (40) sorbitol hexaoleate.
70. The biopesticide composition of item 69, wherein the polyoxyethylene (40) sorbitol hexaoleate includes Cirrasol® G-1086.
71. The biopesticide composition of any of items 64-70, wherein the total amount of surfactant is between at least one of about 1 to about 50 wt. %, about 2 to about 30 wt. %, about 24 to about 36 wt. %, about 27 to about 33 wt. %, and about 29 to about 31 wt. %.
72. The biopesticide composition of any of items 64-70, wherein the total amount of sorbitan fatty acid surfactant is between about 0.5 to about 7.5 wt. % and the total amount of sorbitol ethoxylate ester surfactant is between about 7.5 to about 30 wt. %.
73. The biopesticide composition of any of items 64-72, wherein the ratio of the sorbitan fatty acid surfactant to the ethoxylate ester surfactant is between about 0.02 to 1 to about 0.25 to 1.
74. The biopesticide composition of any of items 64-73, wherein the total amount of surfactant is about 30 wt. %, the sorbitan fatty acid surfactant includes a sorbitan monooleate, the sorbitol ethoxylate ester surfactant includes a polyoxyethylene (40) sorbitol hexaoleate, and the ratio between the sorbitan monooleate and the polyoxyethylene (40) sorbitol hexaoleate is about 0.08 to 1.
75. The biopesticide composition of any of items 64-74, wherein the at least one carrier comprises one or more paraffinic oils.
76. The biopesticide composition of any of items 64-74, wherein the at least one carrier comprises SunSpray 6N oil (available from Sunoco, Petronas Lubricants, Belgium Nev.).
77. The biopesticide composition of any of items 64-76, wherein the biopesticide composition further comprises an anti-settling agent.
78. The biopesticide composition of any of items 64-76, wherein the biopesticide composition further comprises an anti-settling agent, wherein the anti-settling agent comprises a fumed silica.
79. The biopesticide composition of any of items 52-78, wherein the spraying is performed once.
80. The biopesticide composition of any of items 52-78, wherein the spraying is performed more than once such as 2, 3, 4, 5, 6, 7, 8, 9, 10 or more than 10 times.
81. The biopesticide composition of any of items 52-64, wherein the administering comprises addition of a dosage from 1×10⁴ to 1×10⁷ conidia of the entomopathogenic fungi per square cm poultry surface.
82. The biopesticide composition of any of items 52-81, wherein the controlling of an insect pest reduces the number of one or more types of insects on the poultry.
83. The biopesticide composition of any of items 52-82, where the number of one or more types of insects on the poultry is reduced by at least 5%, such as at least 10%, for example by at least 15%, such as by at least 20%, for example by at least 25%, such as by at least 30%, for example by at least 35%, such as by at least 40%, for example by at least 45%, such as by at least 50%, for example by at least 55%, such as by at least 60%, for example by at least 65%, such as by at least 70%, for example by at least 75%, such as by at least 80%, for example by at least 85%, such as by at least 90%, for example by at least 95%, such as by at least 99%, or for example by 100%.
84. The biopesticide composition of item 83, wherein the number of one or more types of insects on the poultry is reduced by at least 5%, such as at least 10%, for example by at least 15%, such as by at least 20%, for example by at least 25%, such as by at least 30%, for example by at least 35%, such as by at least 40%, for example by at least 45%, such as by at least 50%, for example by at least 55%, such as by at least 60%, for example by at least 65%, such as by at least 70%, for example by at least 75%, such as by at least 80%, for example by at least 85%, such as by at least 90%, for example by at least 95%, such as by at least 99%, or for example by 100% determined 24 hours, 48 hours, 72 hours or 96 hours after the administration.
85. The biopesticide composition of any of items 52-84, wherein the controlling of an insect pest partly or completely exterminates insects of one or more types on the poultry.
86. The biopesticide composition of item 85, wherein the controlling of an insect pest partly or completely exterminates insects of one or more types on the poultry determined 24 hours, 48 hours, 72 hours or 96 hours after the administration.
87. The biopesticide composition of any of items 52-86, wherein the poultry is selected from the group consisting of Galloanserae, Anatidae, Galliformes, Anseriformes chickens, Guineafowls, quails, turkeys, ducks and geese.
88. The biopesticide composition of any of items 52-87, wherein the poultry is selected from broilers and layers.
89. The biopesticide composition of any of items 52-88, wherein the insect pest is selected from an insect of the group consisting of mites, fleas, flies, louse, ticks and bugs.
90. The biopesticide composition of any of items 52-89, wherein the insect pest is an insect selected from the group consisting of Northern fowl mites (Ornithonyssus sylviarum), Red Mite (Dermanyssus gallinae), Chicken Flea (Ceratophyllus Gallinae), Scaly-leg mites (Knemidokoptes mutans), Sticktight fleas (Echidnophaga gallinacea), chicken body louse (Menacanthus stramineus), shaft louse (Menopon gallinae), Chicken mites (Dermanyssus gallinae), Fowl ticks (Argas persicus), and Bedbugs (Cimex lectularius).
91. The biopesticide composition of any of items 52-90, wherein the biopesticide composition having an effective amount of one or more entomopathogenic fungi further comprises a chemical pesticide.

### EXAMPLES

### Deposit of Biological Material

The following biological materials were deposited under the terms of the Budapest Treaty at deposited with Agricultural Research Service Culture Collection (NRRL), 1815 North University Street. Peoria. Ill. 61604. U.S.A. and given the following accession numbers:

| Deposit | Accession Number | Date of Deposit |
|---|---|---|
| Metarhizium anisopliae | NRRL-67280 | Jul. 1, 2016 |

The strain has been deposited under conditions that assure that access to the culture will be available during the pendency of this patent application to one determined by foreign patent laws to be entitled thereto. The deposits represent a substantially pure culture of the deposited strain. The deposits are available as required by foreign patent laws in countries wherein counterparts of the subject application or its progeny are filed. However, it should be understood that the availability of a deposit does not constitute a license to practice the subject invention in derogation of patent rights granted by governmental action.

### Example 1

### Background

The miticidal effect of Met52® EC comprising the Metarhizium anisopliae strain having the deposit accession number NRRL 67280 (Novozymes) was compared to Permethrin SFR (Control Solutions Inc.) and Rabon™ 50WP (Bayer), two commonly-used insecticides in a chicken facility with a known infestation of Northern Fowl Mites (Ornithonyssus sylviarum).

### Method

Met52® EC (Novozymes) was prepared by mixing at a rate of 0.8 fluid ounce (30 mL) of MET52® (Novozymes) per 1 gallon of water. Permethrin SFR (Control Solutions Inc.) was prepared for application by mixing at the manufacturer's recommended rate of 1 fluid ounce (30 mL) of Permethrin SFR (Control Solutions Inc.) per 1 gallon of water. Rabon™ WP (Bayer) was prepared for application by mixing at the manufacturer's recommended rate of 2 pounds to 25 gallons of water/4 pounds to 50 gallons of water.

Random half-house treatments were assigned. 20 randomly-selected breeder chickens within each treatment area were evaluated and coded for Northern Fowl Mites population using the scale in Table 1. Treatments were color-coded to help in identifying treated birds and differentiating between treatments. Treatments were applied by spraying 35 ml of the appropriate diluted substance directly onto the vent area of each of 4000 chickens per treatment group. 24 hours and 7 days after treatment, 20 randomly-selected chickens from each treatment area were evaluated and coded for Northern Fowl Mites population.

TABLE 1
Scoring system for Northern Fowl Mites
visualized on chickens used throughout the study

| Score | Northern Fowl Mites per sq. cm. |
|---|---|
| 0 | 0 |
| 1 | 1-10 |
| 2 | 11-100 |
| 3 | >100 |

### Results

As shown in Table 2, all three treatments results in lowered Northern Fowl Mite scores at both 24-hour and 1-week time points as compared to the pretreatment score. 24 hours after treatment, Rabon™ 50WP (Bayer) and MET52® EC (Novozymes) resulted in very similar Northern Fowl Mite scores, 7 days after treatment, MET52® EC (Novozymes) resulted in a comparatively lower score than either of the chemical insecticide treatments.

TABLE 2
Average Northern Fowl Mite scores for three treatment groups
prior to treatment, 24 hours after treatment and 7 days after treatment.

| | | 24 Hours after | 7 Days after |
|---|---|---|---|
| Treatment | Prior to treatment | treatment | treatment |
| MET52 ® EC | 3 | 1.8 | 1.2 |
| Permethrin SFR | 3 | 2.21 | 1.65 |
| Rabon ™ 50WP | 3 | 1.71 | 1.95 |

1. A method for controlling an insect pest on poultry comprising:
(a) preparing a biopesticide composition having an effective amount of one or more Metarhizium spp.; and
(b) spraying said biopesticide composition onto the poultry,
wherein the biopesticide composition further comprises at least one surfactant and at least one carrier.

2. The method of claim 1, wherein said Metarhizium spp. is Metarhizium anisopliae or Metarhizium brunneum.

3. The method of claim 1, wherein said Metarhizium spp. is Metarhizium anisopliae strain having the deposit accession number NRRL 67280; a strain having all of the identifying characteristics of Metarhizium anisopliae strain having the deposit accession number NRRL 67280 or a mutant thereof.

4. The method of claim 1, wherein the Metarhizium spp. is in spore form.

5. The method of claim 1, wherein the biopesticide composition is in a liquid form.

6. The method of claim 1, wherein the spraying is performed once.

7. The method of claim 1, wherein the spraying is performed more than once.

8. The method of claim 1, wherein the administering comprises addition of a dosage from 1×10⁴ to 1×10⁷ of conidia of the entomopathogenic fungi per square cm poultry surface.

9. The method of claim 1, wherein the number of one or more types of insects on the poultry is reduced by at least 5% determined 24 hours after the administration.

10. The method of claim 1, wherein the controlling of an insect pest partly or completely exterminates insects of one or more types on the poultry determined 24 hours after the administration.

11. The method of claim 1, wherein the poultry is selected from the group consisting of Galloanserae, Anatidae, Galliformes, Anseriformes chickens, Guineafowls, quails, turkeys, ducks and geese.

12. The method of claim 1, wherein the insect pest is selected from an insect of the group consisting of mites, fleas, flies, louse, ticks and bugs.

13. (canceled)

14. A biopesticide composition having an effective amount of one or more Metarhizium spp. for controlling an insect pest on poultry, wherein the biopesticide composition further comprises at least one surfactant and at least one carrier.

15. The biopesticide composition of claim 14, wherein said Metarhizium spp. is Metarhizium anisopliae strain having the deposit accession number NRRL 67280; a strain having all of the identifying characteristics of Metarhizium anisopliae strain having the deposit accession number NRRL 67280 or a mutant thereof.
